(19) United States
(12) Patent Application Publication
(10) Pub. No.: US 2006/0287431 A1
(43) Pub. Date: Dec. 21, 2006

(54) Polymer networks

(75) Inventor: Werner Siol, Darmstadt (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: ROEHM GBMH & CO. KG, Darmstadt (DE)

(21) Appl. No.: 10/571,116

(22) PCT Filed: Sep. 20, 2004
(86) PCT No.: PCT/EP04/10518

§ 371 Date: Mar. 8, 2006

(30) Foreign Application Priority Data
Sep. 25, 2003 (DE) 103 44 412.2

(51) Int. Cl. C09D 5/02; C08L 31/00

(52) U.S. Cl. 524/556; 526/318.44

(57) ABSTRACT

The invention relates to polymer networks comprising dimethacrylates of formula CH₂═CCH₃COO—X—O—COCCH₃═CH₂ and thiols as main components, X representing a bifunctional radical. Said dimethacrylate/modifier networks represent materials whose properties are determined essentially by the properties of the X group as a result of the very short polymethacrylate blocks used. The networks are very soft and flexible or highly solid, tough, and solvent-resistant depending on the type of the X group that is used.

### FIELD OF THE INVENTION

The invention relates to polymer networks derived from dimethacrylates and of mercaptans as main constituent.

### PRIOR ART

Dimethacrylates, i.e. methacrylic esters of dihydric alcohols, e.g. butanediol dimethacrylate, are very generally used for the crosslinking of polymers. Unlike diacrylates, which are also used at high concentration, the dimethacrylates, which are more bulky, are generally not used in pure form. For example, in DE 36 16 176 the proportion of the dimethacrylates is restricted to proportions <30% during production of scratch-resistant layers based on polyfunctional (meth)acrylates.

There are also differences between diacrylates and dimethacrylates with respect to the action of chain transfer agents during free-radical polymerization. For example, Nie et al. show that a marked increase in the termination rate is observed during the photopolymerization of diacrylates and dimethacrylates in the presence of dodecanethiol as transfer agent, in particular in the case of the methacrylates (Jun Nie et al. “Chain Length Dependent Termination in the Polymerization of Highly Crosslinked Multifunctional (Meth)acrylates”, presented at (197) Cure and Degradation Kinetics of Thermosetting Systems (also available for consultation on the Internet at http://www.aiche.org/conferences/techprogram/paperdetail. asp?PaperID=1875&DSN=annual99)).

Diacrylates are now widely used in applications such as production of UV-curing lacquers, for reasons including high polymerization rate (acrylates polymerizing about 40 times faster than methacrylates), but use of pure or high-concentration dimethacrylates is rather rare. By way of example here, mention may be made, of the polyesters having methacrylate end groups of EP 1223182, or the dimethacrylates of DE 698 01 554. DE 42 34 256 describes polymer networks based on alkyl thiols having at least 2 thiol groups.

### OBJECT AND ACHIEVEMENT OF OBJECT

There continues to be a requirement for networks based on dimethacrylates which utilize the advantages of the polymethacrylates (e.g. high weathering resistance) to construct high-performance networks.

Polymer networks have now been found which meet these requirements.

These polymer networks contain, in polymerized form,
A) from 60 to 100 parts of dimethacrylates of the formula (1)
   CH₂═CCH₃COO—X—O—COCCH₃═CH₂, (1)
where X is a bifunctional radical from the group of the unsubstituted or substituted alkanes, esters, dimethylsiloxanes, and polypropylene oxides,
B) from 40 to 0 parts of vinyl compounds B copolymerizable with (1),
C) from 1 to 40 parts of mercaptans RS—H where the molar ratio of dimethacrylate to mercaptan is <10, preferably <5.

These polymer networks preferably contain dimethacrylate and mercaptan in a molar ratio in the range from 1.5 to 4.5.

The structure of polymer networks of interest is such that X is an alkylidene radical having from 8 to 300, preferably from 10 to 40, carbon atoms. By way of example, mention may be made of decanediol dimethacrylate or dodecanediol dimethacrylate, or alkylidene dimethacrylates having even longer chains, e.g. poly(ethylene-co-1,2-butylene)diol dimethacrylate whose Mₙ is about 3000.

Polymer networks of particular interest are obtained if X is a bifunctional radical having ester groups:
X=-(-A-OCO—B—COO-)ₘ-A-, -(-D-COO-)ₙ-A-(-OCOD-)ₙ-,

in which A, B, and D, independently of one another, are an alkylidene or arylidene radical having from 2 to 20 carbon atoms, m is from 1 to 100, and n is from 1 to 50.

By way of example, A is 1,2-ethylidene (—CH₂—CH₂—), B is octamethylene or 1,4-phenylene, and D is 1,1-ethylidene or phenylene.

Mention may therefore be made of the following constituents of the bifunctional radical X: lactic acid (D=1,1-ethylidene), terephthalic acid (B=phenylene), ethylene glycol (A=ethylidene), the result as dimethacrylate (1) using A and B being, by way of example, the bis(2-methacryloyloxyethyl) ester of terephthalic acid.

These polymer networks derived from dimethacrylates (1) containing ester groups and of mercaptans have excellent suitability for constructing hydrolytically degradable articles.

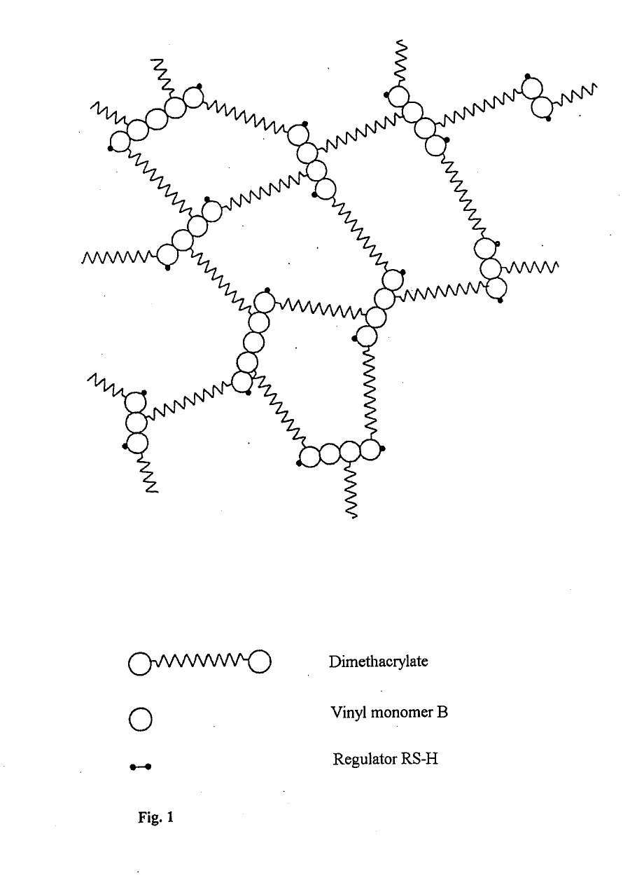

As FIG. 1 shows, the inventive networks are composed of very short-chain polymethacrylate blocks crosslinked only by way of the dimethacrylates (1). Hydrolysis of the ester groups of the bifunctional radical X therefore leads to breakdown of the entire network. The degradability of the inventive networks can be controlled simply via the susceptibility to hydrolysis of the ester groups forming the bifunctional radical X. On the other hand, FIG. 1 also illustrates that it is possible to prepare very soft polymer networks when very long-chain, flexible bridges X are used. Mention may be made here by way of example of the dimethacrylates of poly(dimethylsiloxane) having bis(hydroxyalkyl) end groups (e.g. with Mn about 5600), or of the dimethacrylic esters of polyethylene glycol-co-propylene glycol with Mn of 2500 or 12 000.

Very soft networks of this type are by way of example suitable as a constituent of antidrumming compositions.

The use of pure polyethylene glycols as constituent of X is less preferred.

Many of the inventive, amorphous polymer networks feature high permeability to light and low haze.

As illustrated in FIG. 1, because the polymethacrylate blocks are very short, the inventive dimethacrylate/regulator networks are materials whose properties are determined via the properties of the groups X, in particular in the case of relatively large bifunctional radicals X. According to the invention, the polymethacrylate sequences are very short, extending to tetramers, trimers, or dimers, and in principle therefore they are merely a linkage system for the quantitatively greater proportions of the constituents forming X.

This permits construction of very tough, solvent-resistant networks. Mention may be made here of networks having aromatic groups, in particular having groups which have a tendency to crystallize. By way of example here, mention may be made of the abovementioned bis(2-methacryloyloxyethyl) ester of terephthalic acid.

As can be seen very clearly from FIG. 1, a very small proportion of vinyl monomers B copolymerizable with the dimethacrylates (1) has no adverse effect on the properties of the inventive network derived from dimethacrylates and from mercaptans. B is generally (meth)acrylic acid and its derivatives, preference being given here to methacrylic esters having from 1 to 18 carbon atoms in the alkyl radical. These vinyl monomers B serve by way of example for better incorporation of initiators, or as adhesion promoters or cohesion improvers for the polymer networks. Other monomers B of particular interest are monomethacrylic esters of the diols HO—X—OH, i.e. esters of the type represented by CH₂═CCH₃COO—X—OH.

The proportion of the monomers B is restricted to <40 parts by weight or preferably <20% by weight, particularly preferably <5% by weight.

Polymerization regulators of the type represented by the mercaptans are significant for the polymer networks. Particular mention may be made here of mercaptans having only one SH group, examples being alkanethiols having from 1 to 18 carbon atoms, e.g. butanethiol, or very generally esters of thioglycolic acid, of thiolactic acid, or of other SH-containing carboxylic acids, e.g. 2-ethylhexyl thioglycolate.

The length of the methacrylate blocks can be controlled very well by way of the ratio of dimethacrylate to mercaptan, and in the preferred case here each polymethacrylate chain bears an initial RS group and a —H end group. The molar ratio of dimethacrylate to mercaptan is generally <12, preferably <10, and particularly preferably <5.

The inventive networks are preferably entirely, i.e. to an extent of >90% or preferably to an extent of >95%, composed of the components of A), B), and C).

In a process of particular interest for preparation of networks from dimethacrylate and from mercaptans, dimethacrylates of formula (1) and mercaptans RS—H are polymerized under free-radical polymerization conditions in a molar ratio of dimethacrylate to mercaptan of from 1.5:1 to 10:1. Photoinitiators, high-energy radiation, or preferably thermal or redox initiators, can be used here. Examples which may be mentioned of thermal initiators are: azo compounds or peroxides, in particular peroxy esters, e.g. tert-butyl 2-ethylperoxyhexanoate.

Proportions which may be used of the initiators are generally from 0.01 to 5% by weight, based on the dimethacrylates. The polymerization temperature is generally in the range from 0 to 100° C.

### EXAMPLES

### Inventive Example 1 Molar Ratio of Dimethacrylate to Mercaptan=3.9

A solution of 20 mg of azoisobutyronitrile (AIBN) in a mixture composed of 8.56 g of 1,10-decanediol dimethacrylate (27.6 mmol) and 1.45 g of 2-ethylhexyl thioglycolate (7.12 mmol) is charged to a glass mold, devolatilized at about 20 mbar, covered with argon, and polymerized at 70° C. in a heating cabinet.

This gives a brilliant, glass-clear, defect-free molding of good strength.

Permeability to light >90%, haze <10%.

### Inventive Example 2 Molar Ratio of Dimethacrylate to Mercaptan=2.0

A solution of 32 mg of AIBN in a mixture composed of 7.56 g of 1,10-decanediol dimethacrylate (24.4 mmol) and 2.48 g of 2-ethylhexyl thioglycolate (12.2 mmol) is polymerized as in inventive Example 1.

This gives a brilliant, glass-clear, defect-free molding, which is flexible and markedly softer than the molding of inventive Example 1.

Permeability to light >90%, haze <10%.

### Comparative Example 1 Non-Inventive

A solution of 20 mg of AIBN is dissolved in 9.92 g of 1,10-decanediol dimethacrylate and polymerized as in inventive Example 1.

This gives a hard, cracked molding.

1. A polymer network, comprising in polymerized form
A) from 60 to 100 parts of dimethacrylates of the formula (1)
CH₂═CCH₃COO—X—O—COCCH₃═CH₂, (1)
where X is a bifunctional radical from the group of the unsubstituted or substituted alkanes, esters, dimethylsiloxanes, and polypropylene oxides,
B) from 40 to 0 parts of vinyl compounds B copolymerizable with (1),
C) from 1 to 40 parts of mercaptans RS—H characterized in that the molar ratio of dimethacrylate to mercaptan is <10.

2. The polymer network as claimed in claim 1, wherein the molar ratio of dimethacrylate to mercaptan is in the range from 1.5 to 4.5.

3. The polymer network as claimed in claim 1, wherein X is an alkylidene radical having from 8 to 300 carbon atoms.

4. The polymer network as claimed in claim 1, wherein
X=-(-A-OCO—B—COO-)ₘ-A-, -(-D-COO-)ₙ-A-(-OCOD-)ₙ-,
in which A, B, and D, independently of one another, are an alkylidene or arylidene radical having from 2 to 20 carbon atoms, m is from 1 to 100, and n is from 1 to 50.

5. A method for the production of a hydrolytically degradable article comprising producing an article with the polymer network as claimed in claim 4.

6. A method for the production of an antidrumming composition comprising producing, an antidrumming composition with the polymer network as claimed in claim 1.

7. A process for preparation of polymer networks as claimed in claim 1, wherein dimethacrylates of formula (1) and mercaptans RS—H are polymerized under free-radical polymerization conditions in a molar ratio of dimethacrylate to mercaptan of from 1.5:1 to 10:1.
